(19) United States
(12) Patent Application Publication
(10) Pub. No.: US 2025/0298694 A1
(43) Pub. Date: Sep. 25, 2025

(54) USER DATA BLOCK LEVEL ACCESS COUNTER

(71) Applicant: Micron Technology, Inc., Boise, ID (US)

(72) Inventors: Graziano MIRICHIGNI, Vimercate (IT); Danilo CARACCIO, Milano (IT); Marco SFORZIN, Cernusco Sul Naviglio (IT); Daniele BALLUCHI, Cernusco Sul Naviglio (IT); Alessandro ORLANDO, Milano (IT); Massimiliano TURCONI, Gorgonzola (IT)

(21) Appl. No.: 19/057,258

(22) Filed: Feb. 19, 2025

Related U.S. Application Data
(60) Provisional application No. 63/567,195, filed on Mar. 19, 2024.

(51) Int. Cl. G06F 11/10; G06F 11/07

(52) U.S. Cl. CPC G06F 11/1068; G06F 11/0772; G06F 11/1016

(57) ABSTRACT

In some implementations, a memory device may receive a request to access host data stored in a user data block, wherein the user data block includes: a data portion in which the host data is stored, an error correction portion in which error correction bits associated with correcting errors in the host data are stored, a metadata portion in which metadata bits associated with the host data are stored, and an access counter portion in which an access counter associated with a quantity of accesses to the user data block is stored. The memory device may access the user data block. The memory device may increment the access counter based on accessing the user data block.

### CROSS-REFERENCE TO RELATED APPLICATION

This Patent Application claims priority to U.S. Provisional Patent Application No. 63/567,195, filed on Mar. 19, 2024, entitled “USER DATA BLOCK LEVEL ACCESS COUNTER,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a user data block level access counter.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system capable of implementing a user data block level access counter.

FIGS. 2A-2H are diagrams of an example associated with a user data block level access counter.

FIG. 3 is a flowchart of an example method associated with using a user data block level access counter.

### DETAILED DESCRIPTION

In some memory systems, a controller may track a quantity of accesses (e.g., read operations and/or write operations) to a portion of memory. For example, an access counter (sometimes referred to herein as a hotness counter (HC)), may be used by a memory system to determine if a certain portion of memory is accessed relatively frequently, sometimes referred to as being “hot,” or is accessed relatively infrequently, sometimes referred to as being “cold.” In such systems, the HC may be used by the memory system to make informed decisions about data management, such as by maintaining frequently accessed data (e.g., hot data) in a memory location that is easily accessible by the system in order to speed up access times, moving rarely used data (e.g., cold data) to a slower storage, and/or the like. Implementing a HC may be resource intensive because the memory system may use high memory overhead to store the HC and/or because the memory system may be required to consume high power, computing, and other resources to track the accesses and/or increment and/or reduce the HC, as needed. Moreover, a granularity of the HC may provide limited information as to which portions of the memory are hot or cold and/or which data is hot or cold, because the HC may track accesses to relatively large memory portions (e.g., blocks and/or pages of memory).

Some implementations described herein enable a user data block level access counter with reduced overhead and/or resource consumption as compared to traditional HCs, or the like. A user data block refers to a portion of volatile memory that can be accessed during a single access of the volatile memory. In some examples, a user data block may include portions of multiple memory components (e.g., dies). For example, a first user data block may be associated with a first portion of each memory component; a second user data block may be associated with a second portion of each memory component; and so forth. In some implementations, a memory device may store an access counter at a user data block, such as a 64 byte (B) user data block that stores data, error correction information associated with the data (e.g., parity information, cyclic redundancy check (CRC) information, and/or the like), and/or metadata. In such implementations, a portion of the metadata storage may be used to store the access counter, which is turn is incremented each time the user data block is accessed to track accesses on a user data block level. Accordingly, a memory system may monitor a hotness and/or coldness of each individual user data block, thereby enabling informed determinations as to which user data blocks are to be promoted to main memory, which user data blocks are to be compressed and/or demoted from main memory, and/or which user data blocks are to be moved to a deep sleep state; enabling enhanced monitoring data to be provided to a host, such as for statistical analysis and/or to make memory-related decisions; and/or enabling tracking of row hammering attacks in certain memory systems (e.g., compute express link (CXL) compliant memory systems); among other examples. As a result, the user data block level access counter may be less resource intensive than traditional HCs, because no additional overhead is needed to store the access counter (e.g., the access counter may be stored within the user data block) and/or the user data block level access counter may provide improved granularity as compared to traditional HCs (e.g., the access counter may track a hotness or coldness of individual user data blocks), thereby enabling more efficient memory operations and thus reduced power, computing, and other resource consumption. Additionally, or alternatively, rather than relying on a statistical approach as in the case for certain traditional access counters, the user data block level access counter may be capable of providing perfect access tracking (e.g., the user data block access counter may be referred to as a perfect memory access profiler), enabling more accurate access tracking and thus improved memory operations.

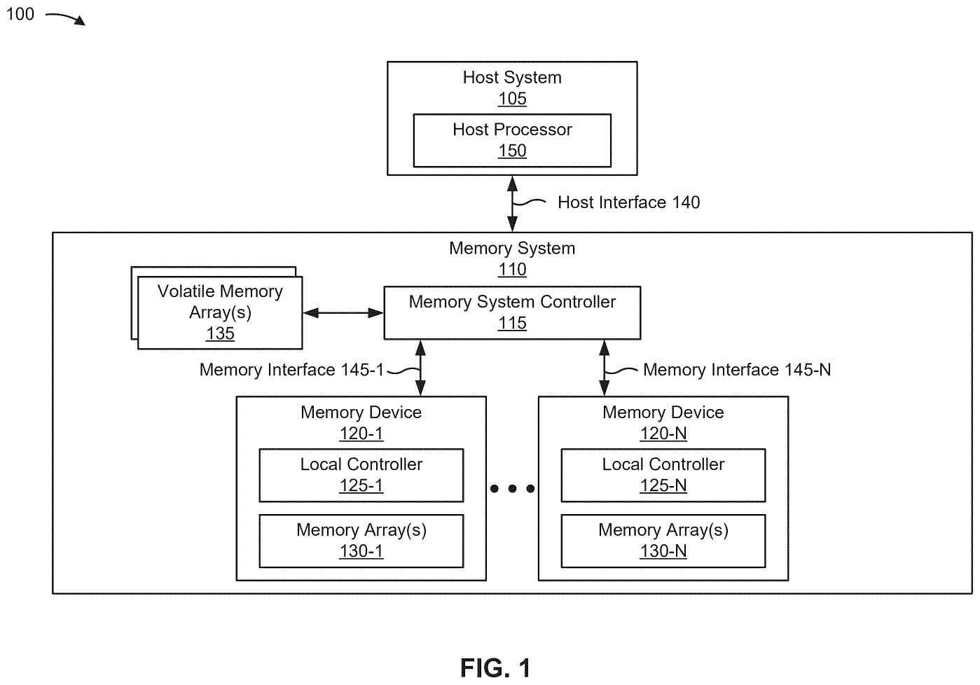

FIG. 1 is a diagram illustrating an example system 100 capable of implementing a user data block level access counter. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

In some examples, the memory system 110 may be a CXL compliant memory system (sometimes referred to herein simply as a CXL memory system) and/or one or more of the memory devices 120 may be CXL compliant memory devices (sometimes referred to herein simply as a CXL memory device). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide an advanced protocol in areas such as input/output (I/O) protocol, memory protocol, and coherency interface.

In some examples, the memory system 110 may include a PCIe/CXL interface (e.g., the host interface 140 may be associated with a PCIe/CXL interface), which may be a physical interface configured to connect the CXL memory system and/or the CXL memory device to CXL compliant host devices. In such examples, the PCIe/CXL interface may comply with CXL standard specifications for physical connectivity, ensuring broad compatibility and case of integration into existing systems using the CXL protocol. Additionally, or alternatively, a CXL memory system and/or a CXL memory device may be designed to efficiently interface with computing systems (e.g., the host system 105) by leveraging the CXL protocol. For example, a CXL memory system and/or a CXL memory device may be configured to utilize high-speed, low-latency interconnect capabilities of CXL, such as for a purpose of making the CXL memory system and/or the CXL memory device suitable for high-performance computing, data center applications, artificial intelligence (AI) applications, and/or similar applications.

A CXL memory system and/or a CXL memory device may include a CXL memory controller (e.g., memory system controller 115 and/or local controller 125), which may be configured to manage data flow between memory arrays (e.g., volatile memory arrays 135 and/or memory arrays 130) and a CXL interface (e.g., a PCIe/CXL interface, such as host interface 140). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

A CXL memory system and/or a CXL memory device may further include and/or be associated with one or more high-bandwidth memory modules (HBMMs) or similar memory arrays (e.g., volatile memory arrays 135 and/or memory arrays 130). For example, a CXL memory system and/or a CXL memory device may include multiple layers of DRAM (e.g., stacked and/or interconnected through advanced through-silicon via (TSV) technology) in order to maximize storage density and/or enhance data transfer speeds between memory layers. Additionally, or alternatively, a CXL memory system and/or a CXL memory device may include a power management unit, which may be configured to regulate power consumption associated with the CXL memory system and/or the CXL memory device and/or which may be configured to improve energy efficiency for the CXL memory system and/or the CXL memory device. Additionally, or alternatively, a CXL memory system and/or a CXL memory device may include additional components, such as one or more error correction code (ECC) engines, such as for a purpose of detecting and/or correcting data errors to ensure data integrity and/or improve the overall reliability of the CXL memory system and/or the CXL memory device.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller.

Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive a request to access host data stored in a user data block, wherein the user data block includes: a data portion in which the host data is stored, an error correction portion in which error correction bits associated with correcting errors in the host data are stored, a metadata portion in which metadata bits associated with the host data are stored, and an access counter portion in which an access counter associated with a quantity of accesses to the user data block is stored; access the user data block; and increment the access counter based on accessing the user data block.

In some implementations, one or more systems, devices, apparatuses, components, and/or controllers of FIG. 1 may be configured to receive, from a host device, a request to access host data stored in a user data block, wherein the user data block includes: a data portion in which the host data is stored, an error correction portion in which error correction bits associated with correcting errors in the host data are stored, a metadata portion in which metadata bits associated with the host data are stored, and an access counter portion in which multiple access counters associated with a quantity of accesses to the user data block are stored; access the user data block; increment a first access counter, of the multiple access counters, based on accessing the user data block; and reduce a second access counter, of the multiple access counters, concurrently with incrementing the first access counter.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

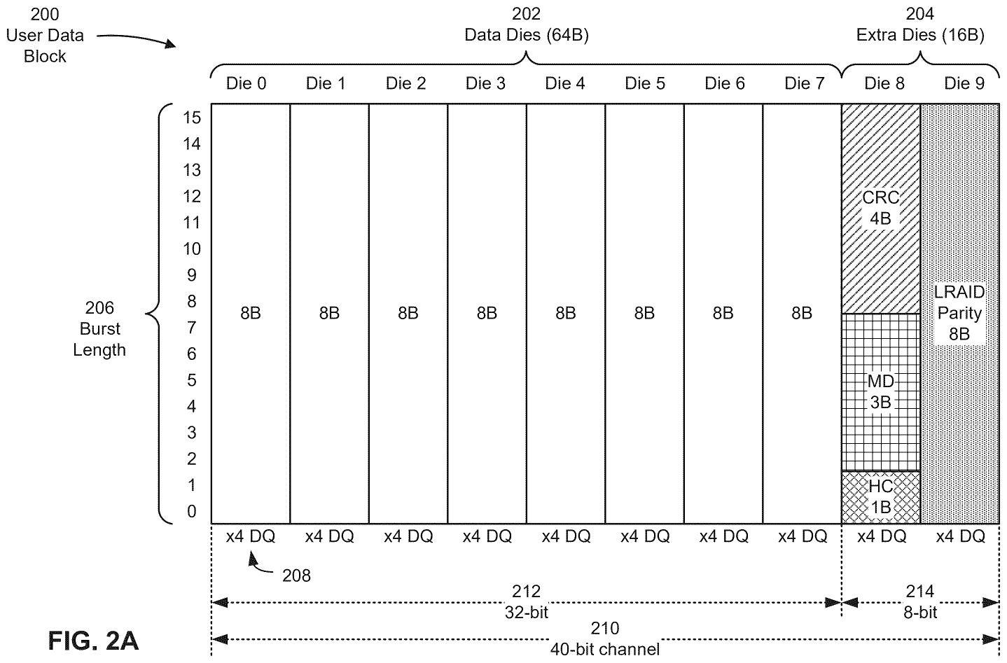

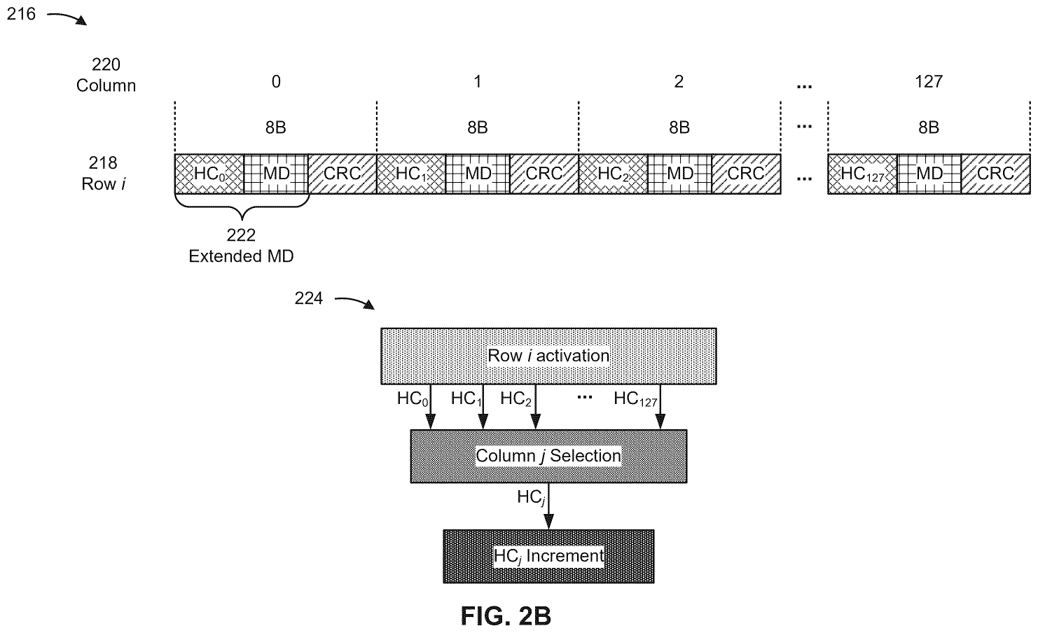

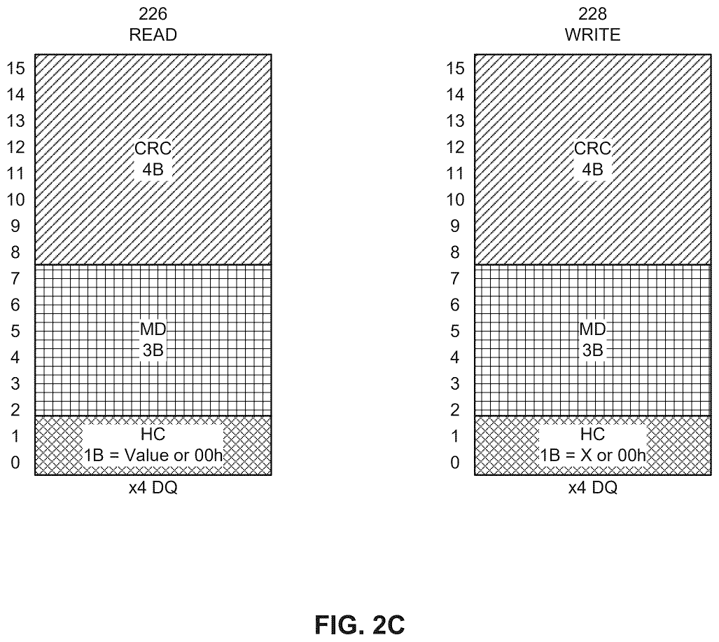

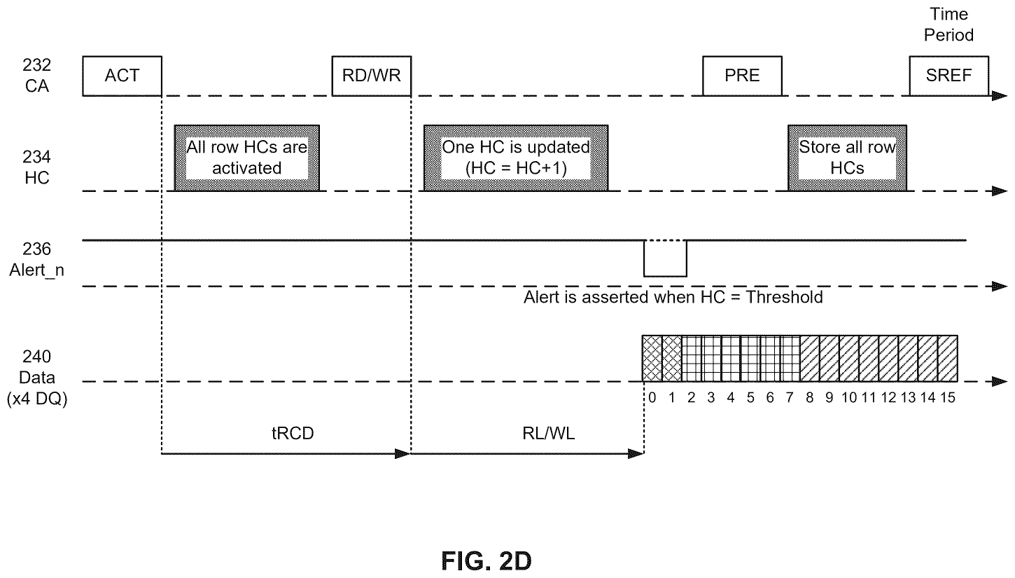

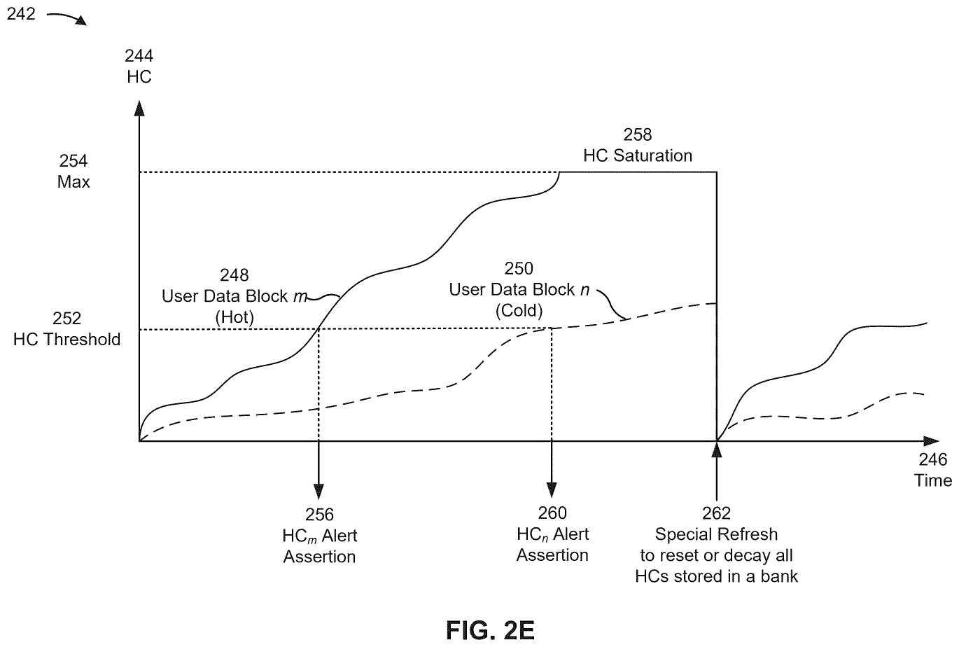

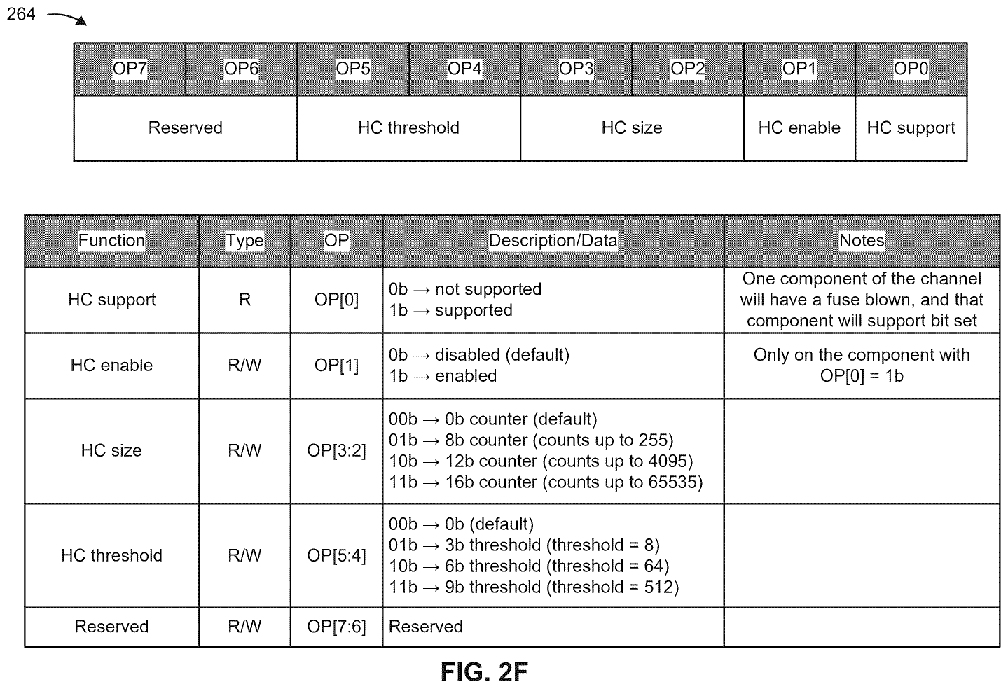

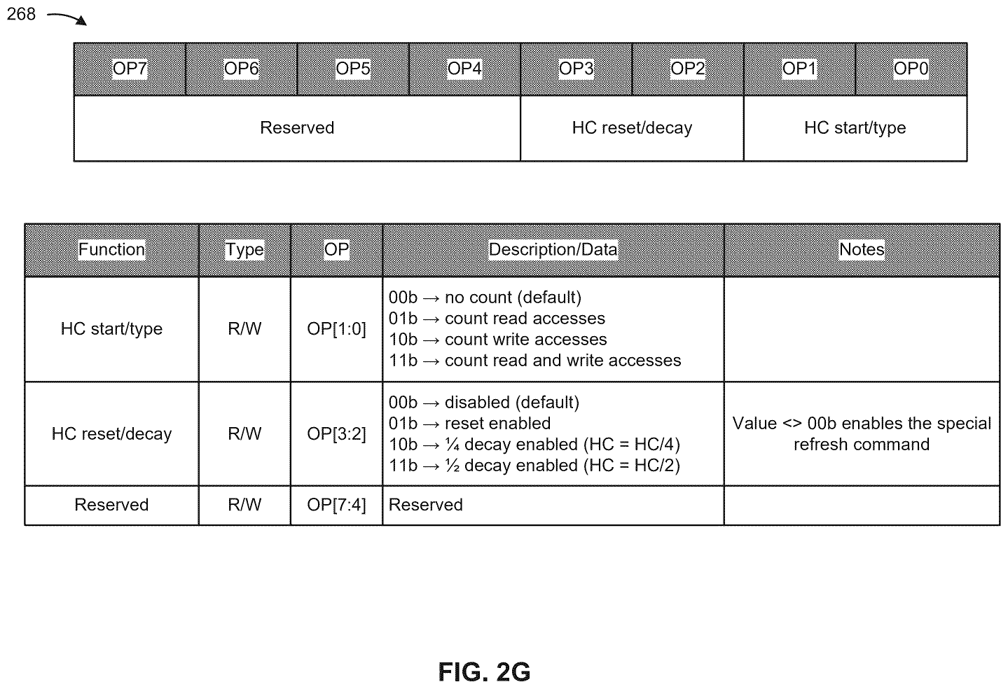

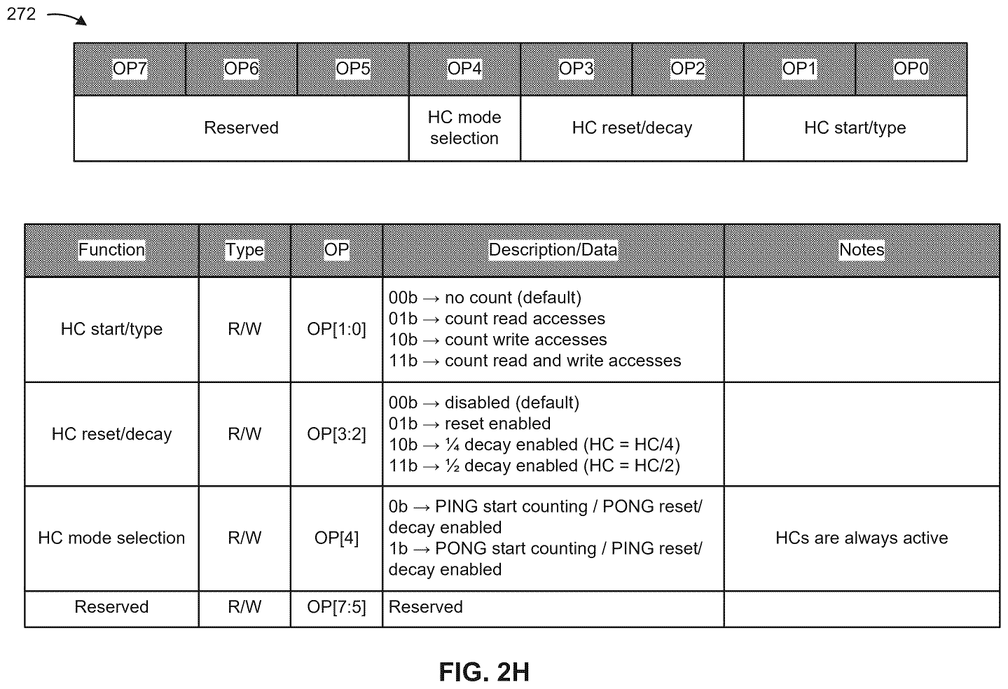

FIGS. 2A-2H are diagrams of an example associated with a user data block level access counter. The operations described in connection with FIGS. 2A-2H may be performed by the memory system 110 and/or one or more components of the memory system 110, such as the memory system controller 115, one or more memory devices 120, and/or one or more local controllers 125.

FIG. 2A shows an example user data block 200 associated with an HC (e.g., an access counter). In some implementations, the user data block 200 may additionally or alternatively be referred to as a memory frame, a memory stripe, a data block, a data frame, a device physical address (DPA), a cacheline, and/or a similar term. The user data block 200 may correspond to a portion of the volatile memory arrays 135 described above in connection with FIG. 1. In some implementations, the user data block 200 may be associated with a memory channel (e.g., a data pathway between memory and other components of a memory device, such as a memory controller and/or a processor), with a “width” of the memory channel (e.g., measured in bits) referring to a quantity of bits that may be transferred in one operation and/or one memory cycle. For example, the user data block 200 may be associated with a 40-bit channel, and thus a memory device associated with the user data block 200 may be referred to as a 40-bit memory device. For example, the memory device may be a double data rate 5 (DDR5) 40-bit memory device, or a similar device.

The user data block 200 may be associated with multiple components (e.g., dies) of memory used to store data bits, parity bits, metadata bits, HC bits, or similar bits. Put another way, in some examples, multiple data bits, parity bits, metadata bits, HC bits, and/or other bits may be striped across multiple dies associated with the user data block 200. For example, the user data block 200 is associated with ten dies (e.g., ten DRAM dies), indexed as die 0 through die 9, with dies 0-7 used to store data bits (and thus referred to herein as data dies 202) and with dies 8-9 used to store error correction bits (e.g., parity and/or CRC bits), metadata bits, HC bits, and/or the like (and thus referred to herein as extra dies 204). As indicated by reference number 206, the user data block 200 may be associated with a burst length of 16 (e.g., sixteen bit lines indexed 0 through 15) and/or, as indicated by reference number 208, each die may be configured in a “by four” (x4) configuration, such that each die includes four input/output pins (sometimes referred to as DQ pins). In this regard, each die of the user data block 200 may be capable of storing 64 bits (e.g., 8 bytes). In some examples, the user data block 200 may be associated with 64 B of data (corresponding to the eight data dies 202, each capable of storing 8 B) and 16 B of error correction bits, metadata bits, HC bits, or similar bits (corresponding to the two extra dies 204, with each die being capable of storing 8 B).

More particularly, in the example shown in FIG. 2A, die 9 may store 8 B of parity information (e.g., information associated with a locked redundant array of independent disks (LRAID) ECC or a similar ECC), and/or die 8 may store 4 B of CRC information, 3 B of metadata information, and 1 B of HC information. In some other implementations, die 8 may store more or less CRC information (e.g., less than 4 B of CRC information or more than 4 B of CRC information), more or less metadata information (e.g., less than 3 B of metadata information or more than 3 B of metadata information), and/or more or less HC information (e.g., less than 1 B of HC information or more than 1 B of HC information) without departing from the scope of the disclosure. Additionally, or alternatively, in some implementations, the metadata information and the HC information may collectively be referred to as metadata information, such that the portion of the user data block 200 storing the metadata information and the HC information (e.g., the 4 B of die 8) may be referred to as an extended metadata portion of the user data block 200. Moreover, as indicated by reference number 210, the memory stripe may be associated with a 40-bit channel, of which 32 bits may be associated with data bits (as indicated by reference number 212) and 8 bits may be associated with parity bits, CRC bits, metadata bits, and/or HC bits (as indicated by reference number 214).

In some implementations, the HC may be associated with one or more configurable parameters enabling user data block level access tracking (e.g., in order to track accesses, such as read and/or write operations, to the user data block 200). For example, parameters such as HC size, an HC threshold, a type of HC (e.g., a type of accesses to be tracked by the HC), and/or a reset/decay type (e.g., whether HC reset/decay is enabled and/or a decay factor associated with the HC reset/decay) may be user configurable parameters, which are described in more detail below in connection with FIGS. 2F-2H. Additionally, or alternatively, the HC may be updated during host accesses to the user data block 200 (e.g., read accesses and/or write accesses), such as by incrementing the HC in response to an access to the user data block 200. In some implementations, the HC may be periodically reset (e.g., reduced to zero) or decayed (e.g., reduced to a value other than zero, such as according to a user-configurable decay factor), such as during special refresh operations, which are discussed in more detail below in connection with FIGS. 2D-2H. In this regard, the HC may track read, write, or both read and write accesses to the user data block 200, thereby enabling user data block level access counting.

In some implementations, when an HC threshold is satisfied (e.g., when the HC reaches a threshold, which may be a user-configurable parameter), an alert signal (sometimes referred to as Alert_n) may be asserted, alerting a memory controller, a host device, and/or another component that the user data block 200 is hot. In some implementations, HC values for the user data block 200 may be tracked over time and/or may be used to form an HC map over time, such that an evolution of the HC map may be used to determine if the user data block 200 should be promoted to main memory, to determine if the user data block 200 should be compressed and/or demoted from main memory, to determine if the user data block 200 should be moved to a deep sleep state (e.g., such as for a purpose of reducing power consumption in the memory device), to provide monitoring data (e.g., to a host device) for statistical analysis and/or to make certain memory allocation decisions, and/or to provide tracking of row hammering attacks in CXL systems or similar systems.

In some implementations, incrementing an HC for the user data block 200 (e.g., an accessed user data block) may include activating multiple HCs (e.g., activating HCs associated with multiple user data blocks) and incrementing the HC for the user data block 200 while refraining from incrementing HCs associated with other (e.g., non-accessed) user data blocks. For example, as shown in FIG. 2B, and as indicated by reference number 216, in some implementations certain memory components (e.g., dies associated with the user data block 200) may be organized into rows, such as row i indicated by reference number 218, with each row being organized into columns, such as the columns indicated by reference number 220. In such implementations, incrementing the HC for a given user data block (sometimes referred to herein as HCⱼ) may include activating the row including the HC (e.g., row i), and then incrementing HC (e.g., HC=HC+1) for a column corresponding to the user data block.

More particularly, in some implementations a memory die (e.g., a DRAM die) may be organized into 1024 B rows. Accordingly, on a given die that is used to store CRC bits, extended metadata bits 222, and/or similar bits (e.g., die 8 of the user data block 200), with each 8 B of the die corresponding to given user data block (e.g., with 4 B corresponding to CRC information of the user data block 200, 3 B corresponding to metadata information of the user data block 200, and/or 1 B corresponding to HC information of the user data block 200), row activation may identify 128 HCs. Put another, because a prefetch size in some memory devices may be 8 B (corresponding to the x4 DQ configuration times the burst length of 16), each 1024 B row may include 128 columns (e.g., 1024 B/8 B prefetch=128), indexed in FIG. 2B as column 0 through column 127, with each column including a corresponding HC. Accordingly, as indicated by reference number 224, to increment a given HC (e.g., HCⱼ), such as in response to accessing a user data block associated with the HC, a memory device may activate a row including the HC and multiple other HCs (e.g., 127 other HCs), may select a column including the HC from the activated row, and may increment the HC within the selected column (e.g., HCⱼ) while refraining from incrementing the other HCs in the row (e.g., the other 127 HCs in the activated row).

In some implementations, beats associated with the HC may be masked on a controller (e.g., the memory system controller 115, which may be an ASIC controller in a CXL device) or else driven to a fixed value in a read and/or a write procedure associated with the user data block 200, such that channel parity (e.g., the parity bits stored on die 9 of the user data block 200 and/or the CRC bits stored on die 8 of the user data block) need not be updated every time the HC for a given user data block is updated. In this way, the HC may be incremented and/or reduced without altering the CRC bits (e.g., the bits used for error detection) and/or the LRAID parity bits (e.g., the bits used for error correction).

For example, as shown in FIG. 2C, and as indicated by reference number 226, during a read command, a memory device may read the die storing the CRC information, the metadata information, and/or the HC information (among the other dies described above in connection with the user data block 200). In some implementations, the memory device may read the actual value of the HC during the read operation, shown as “Value” in FIG. 2C. In such implementations, the value of the HC may be masked from an error manager component of the memory device (e.g., an error manager ASIC in a CXL device, among other examples), such that the error manager component may perform error correction operations (e.g., may detect any errors in the read data using the CRC information, the channel parity information such as LRAID information, and/or similar information) without the HC value affecting the channel parity and/or the ECC. In some other implementations, the parity information and/or other error correction information may be determined using a fixed value (e.g., 0, shown in FIG. 2C in hexadecimal format 00 h) in place of the HC bits. In such implementations, the fixed value (e.g., 00 h) may be forced on the HC beats during the read operation in order to not alter channel parity and/or otherwise affect the ECC and/or the error correcting capabilities of the error manager component.

Similarly, as indicated by reference number 228, in some implementations, the memory device may write an X value to the HC bits during a write operation. In such implementations, the HC value may be masked from the error manager component, such that the error manager may determine error correction information (e.g., CRC information, channel parity information such as LRAID information, and/or similar ECC information) without using the HC value (e.g., X). In some other implementations, a fixed value (e.g., 00 h) may be forced on the HC beats when determining the error correction information during the write operation in order to not alter channel parity and/or otherwise affect the ECC and/or the error correcting capabilities of the error manager component.

FIG. 2D shows operations performed at various levels and/or layers of a memory device 120, such as for a purpose of implementing a user data block level access counter, including a command/address (CA) level as indicated by reference number 232, an HC level as indicated by reference number 234, an alert level as indicated by reference number 236, and/or a data level as indicated by reference number 240. First, as shown in connection with reference number 232, the memory device may issue an activation (ACT) command to a memory component, which may identify multiple (e.g., 128) HCs to be activated, as described above in connection with FIG. 2B. The activation command may be followed by a timing parameter associated with a row to column delay (tRCD), which may refer to an amount of time required between a row being activated (e.g., a row address being sent to a memory component) and the data in the row being available for a read or write operation. In this way, as shown in connection with reference number 234, all HCs in a row containing an HC to be incremented may be activated during the tRCD, in a similar manner as described above in connection with FIG. 2B.

As further shown by reference number 232, following the activation command, the memory device may issue a read/write (RD/WR) command to the memory component, which may identify a user data block (e.g., user data block 200) to be accessed (e.g., to be read to and/or written to). Accordingly, during a read latency/write latency (RL/WL) time period (e.g., a period of time between issuing a read command and the moment a first bit of requested data is available on the data bus, and/or a period of time between issuing a write command and an actual writing of the data into the memory array), an HC associated with the user data block being accessed may be incremented by one, reflective that the user data block is being accessed. As indicated by reference number 240, following the RL/WL time period, the data to be read and/or freshly written to may be available at the data bus. For case of description, only the memory component of the user data block containing the HC (e.g., die 8 of the user data block 200) is shown at the data bus. Moreover, because in some implementations the data bus may be in a x4 DQ configuration, each box shown in connection with the data bus in FIG. 2D may correspond to 4 bits. In this regard, the first two boxes (indicated using diagonal cross-hatching) may correspond to 8 bits (e.g., 1 B) associated with the HC, the next six boxes (indicated using horizontal and vertical cross-hatching) may correspond to 24 bits (e.g., 3 B) associated with other metadata, and/or the remaining eight boxes (indicated using diagonal hatching) may correspond to 32 bits (e.g., 4 B) associated with other CRC information. In that regard, a value of the HC may be available (e.g., via the DQ pins) to the memory device via a read operation.

Moreover, as shown by reference number 236, if the HC satisfies a threshold, the memory device may cause an alert signal (sometimes referred to herein as Alert_n) to be asserted. The alert signal (e.g., Alert_n) may alert a memory controller, a host device, and/or another device that the user data block is relatively hot. Asserting Alert_n when an HC satisfies a threshold may result in more efficient memory operations, because the memory device, the host device, and/or another device may perform certain actions in real-time as a user data block becomes hot. Moreover, in read operations, information provided at a data bus (e.g., the DQ pins) and the Alert_n may transmit in a same direction (e.g., from the memory to the controller), while, in write operations, information provided at the data bus (e.g., the DQ pins) and the Alert_n may transmit in opposite directions because the controller is writing information on the DQ pins and receiving the Alert_n from the memory.

As further indicated by reference number 232, the memory device may then issue a precharge (PRE) command to the memory component, which may cause the multiple HCs (e.g., the 128 HCs associated with the activated row) to be stored (as indicated by reference number 234). Additionally, or alternatively, and as further indicated by reference number 232, the memory device may periodically issue a special refresh (SREF) command to the memory component. For example, the memory device may determine that a time period associated with tracking one or more user data blocks has elapsed, and thus the memory device may issue the special refresh command to the memory component in order to reduce multiple HCs stored in a bank of memory. Put another way, in some implementations an SREF command may operate at a bank level, and thus all HCs physically stored in a bank may be reset in response to the memory device issuing the SREF command. In some implementations, the time period may be an integer multiple of a reference time period (tREF), which may be equal to a refresh rate of the memory component (e.g., a refresh rate of a DRAM memory component). Additionally, or alternatively, in some implementations, tREF may be 32 milliseconds (ms), and thus the time period for tracking accesses to a user data block (e.g., user data block 200), after which the HC is to be reduced, may be an integer multiple of 32 ms. Based on receiving the special refresh command, the memory device may reduce the HC, such as by resetting the HC to zero or decaying the HC to some non-zero value according to a user-configured decay factor, which is described in more detail below.

More particularly, FIG. 2E shows an example 242 plotting a magnitude of an HC, as indicated by reference number 244, over time, as indicated by reference number 246, for two example user data blocks, shown as user data block m (indicated by reference number 248) and user data block n (indicated as reference number 250). In some implementations, an HC may be associated with an HC threshold, as indicated by reference number 252 and as described above in connection with FIG. 2D, and a maximum value, as indicated by reference number 254 and which may correspond to a count at which the HC maxes out (e.g., 255 for an 8-bit counter, 4,095 for a 12-bit counter, or 65,535 for a 16-bit counter, among other examples). As shown by the curve indicated by reference number 248, user data block m may be a relatively hot user data block (e.g., as compared to user data block n), and thus the HC associated with the user data block (shown as HCₘ) may increase relatively rapidly. If the user data block is configured such that an alert signal (e.g., Alert_n) is enabled, when HCₘ satisfies the HC threshold, the alert may be asserted, as indicated by reference number 256. In some implementations, HCₘ may continue to be incremented for each additional access, until the maximum value of the HC is reached, at which point HCₘ may become saturated (e.g., maxed out) as indicated by reference number 258, and thus HCₘ may remain at the maximum value until HCₘ is reset and/or decayed.

As shown by the curve indicated by reference number 250, user data block n may be a relatively cold user data block (e.g., as compared to user data block m), and thus the HC associated with the user data block n (shown as HCₙ) may increase relatively slowly. In this regard, if the user data block is configured such that an alert signal (e.g., Alert_n) is enabled, the alert may be asserted when HCₙ satisfies the HC threshold, as indicated by reference number 260, which may come after the alert asserted for HCₘ. In some implementations, HCₙ may continue to be incremented for each additional access, but may never reach a saturation point (e.g., the maximum value of the HC) for a given time period, because the user data block is relatively cold.

As indicated by reference number 262, after a certain time period has elapsed, which may be tREF (e.g., 32 milliseconds) or an integer multiple of tREF (e.g., 64 milliseconds, 96 milliseconds, and so forth), a special refresh signal (e.g., SREF) may be issued to reset or decay the HCs, as indicated by reference number 262. For example, in some implementations an SREF may reset all HCs physically stored in a bank of memory (e.g., the HC associated with user data block m, the HC associated with user data block n, and/or HCs associated with other user data blocks belonging to a same user data block bank as user data block m and user data block n) because the SREF command may operate at a bank level. In the example shown in FIG. 2E, the HCs are reset to zero, and thus the HCs may begin counting from zero during a subsequent time period. However, in some other implementations, the special refresh command may decay the HCs to some non-zero value (e.g., according to a user-configured decay factor), which is described in more detail below in connection with FIGS. 2F-2G.

In some implementations, tracking accesses to a user data block via the HC may be paused during a special refresh period (e.g., a period of time during which the HC is reset and/or decayed). Accordingly, in some implementations, multiple HCs may be utilized to perform alternate tracking of user data block (sometimes referred to herein as ping-pong tracking of user data block), in which a first HC (sometimes referred to herein as a PING HC) is active while a second HC (sometimes referred to herein as a PONG HC) is being refreshed, and in which the second HC (e.g., the PONG HC) is active while the first HC (e.g., the PING HC) is being refreshed. In such implementations, continuous tracking of a user data block may be achieved because tracking of a user data block does not need to be suspended while resetting or decaying HCs. Aspects of using multiple HCs to alternately track a user data block is described in more detail below in connection with FIG. 2H.

Additionally, or alternatively, a special refresh command may operate at a bank level. A “bank” of memory may refer to a subset and/or partition of an overall memory array (e.g., memory array 130, which may be a DRAM array in the context of a CXL device, or the like). In some implementations, a bank of memory may include multiple (e.g., 8, 192) rows. Moreover, in implementations associated with DRAM arrays, each memory cell inside the DRAM may need to be refreshed according to a certain periodicity, sometimes referred to as a refresh rate. For example, in some implementations, each memory cell inside a DRAM may need to be refreshed every 32 ms. In implementations in which a bank of memory includes 8,192 rows, the bank of memory may thus require a refresh command every approximately 3.9 microseconds (μs) (e.g., 8,192 rows×3.9 μs/row=32 ms, or the refresh rate). In such implementations, a refresh command may be sent to a bank of memory, and the memory may internally manage a row counter to sequentially refresh all 8,192 rows of the bank.

In some implementations, the SREF command may rely on a need for a memory array (e.g., a DRAM array) to be periodically refreshed according to a refresh rate (e.g., 32 ms). More particularly, the SREF command may be used to provide, in addition to the required refresh of the memory cells described above, a reset and/or decay of the memory cells used as HCs. In such implementations, an SREF command may be sent to a bank of memory, and the memory may internally manage a row counter to perform reset/decay of the HCs in a sequential manner over all the rows within the bank (e.g., over all 8,192 rows of the bank, among other examples). Additionally, or alternatively, the SREF may be performed over multiple banks of a memory device, such as by sending a corresponding SREF command to each of the multiple banks of memory (which, in some implementations, may include 16 banks or another quantity of banks). As described above, in some implementations a second HC (e.g., a PONG HC) may be used to track accesses to a user data block during a period of time when a first HC (e.g., a PING HC) is being reset or decayed, such that continuous tracking of a user data block may be achieved, which is described in more detail below in connection with FIG. 2H.

In some implementations, a memory device (e.g., memory device 120) may receive configuration information configuring one or more parameters associated with the HC, such as via one or more mode registers (MRs) associated with a user data block being monitored (e.g., user data block 200). For example, operational points (OPs) of one or more MRs may be set in order to indicate certain parameters associated with the HC, such as an HC threshold, a size of the portion of the user data block used to store the HC, enablement of the HC, support of the HC, enablement of a reduction of the HC, a reduction type for reducing the HC, a type of one or more accesses to the user data block that are to be counted by the HC, or enablement of one HC, of multiple HCs (e.g., PING and PONG HCs) associated with the user data block, among other parameters.

For example, reference number 264 in FIG. 2F indicates an MR that may be used to configure an HC. In some implementations, the MR indicated by reference number 264 may be referred to as a first HC MR, or simply HC1. HC1 may include eight OPs, indexed as OP0 through OP7. OP0 may be a read-only bit indicating whether an HC is supported for a given memory component. For example, as described above in connection with FIG. 2A, the user data block 200 may include ten components (e.g., dies), with the HC being included on only one component (e.g., die 8) of the ten components. Accordingly, the MR for the component including the HC (e.g., die 8) may have OP0 set to 1 b, indicating that the component supports the HC. This is sometimes referred to as having a “fuse blown” for the certain memory component to indicate that the component is the one supporting and/or storing the HC. OP1 may be a read/write bit indicating whether, for a given component (e.g., the memory component for which the fuse is blown), the HC is enabled. For example, when OP1 is set to 0 b, the HC may be disabled (which may be a default setting), and when OP1 is set to 1 b, the HC may be enabled. In that regard, only a component having a fuse blown (e.g., a memory component for which OP0 is set to 1 b, indicating that the HC is supported) may have the OP1 set to 1 b (e.g., HC enabled). More particularly, in some implementations an MR write command that is used to update MRs may be transmitted in parallel to all components of a channel (e.g., all ten dies of the user data block 200), but only the component with the fuse blown (e.g., die 8) of the channel may have the HC enabled (e.g., OP1=1 b).

OP2 and OP3 may be used to indicate a size of the HC. For example, when OP2 and OP3 are set to 00 b (e.g., a default setting), the HC size may be 0 b; when OP2 and OP3 are set to 01 b, the HC size may be 8 b (which may be capable of counting up to 2⁸−1 accesses to the user data block, or 255 accesses); when OP2 and OP3 are set to 10 b, the HC size may be 12 b (which may be capable of counting up to 2¹²−1 accesses to the user data block, or 4,095 accesses); or when OP2 and OP3 are set to 11 b, the HC size may be 16 b (which may be capable of counting up to 2¹⁶−1 accesses to the user data block, or 65,535 accesses); among other examples. Moreover, OP4 and OP5 may be used to indicate the HC threshold. For example, when OP4 and OP5 are set to 00 b (e.g., a default setting), the HC threshold may be 0 b; when OP4 and OP5 are set to 01 b, the HC threshold may be 3 b (e.g., the HC threshold may be 2³=8); when OP4 and OP5 are set to 10 b, the HC threshold may be 6 b (e.g., the HC threshold may be 2⁶=64); or when OP4 and OP5 are set to 11 b, the HC threshold may be 9 b (e.g., the HC threshold may be 2⁹=512); among other examples. In some cases, certain OPs (e.g., OP6 and OP7 in the implementation shown in FIG. 2F) may be reserved for future use.

Reference number 268 in FIG. 2G indicates another MR that may be used to configure an HC. In some implementations, the MR indicated by reference number 268 may be referred to as a second HC MR, or simply HC2. HC2 may also include eight OPs, indexed as OP0 through OP7. OP0 and OP1 may be used to indicate an HC start/type. For example, when OP0 and OP1 are set to 00b (e.g., a default setting), the HC may count no accesses to the user data block; when OP0 and OP1 are set to 01 b, the HC may count only read accesses to the user data block; when OP0 and OP1 are set to 10 b, the HC may count only write accesses to the user data block; or when OP0 and OP1 are set to 11 b, the HC may count both read and write accesses the user data block; among other examples. Moreover, OP2 and OP3 may be used to indicate an HC reset/decay type. For example, when OP2 and OP3 are set to 00 b (e.g., a default setting), the HC reset/decay may be disabled (e.g., refresh commands may be standard, without reset and/or decay capability); when OP2 and OP3 are set to 01 b, HC reset may be enabled (e.g., the HC may be reset to zero); when OP2 and OP3 are set to 10b, ¼ HC decay may be enabled (e.g., the HC may be set to ¼ of its current value); or when OP2 and OP3 are set to 11 b, ½ HC decay may be enabled (e.g., the HC may be set to ½ of its current value); among other examples. In this regard, any value other than 00 b in OP2 and OP3 may enable the special refresh command described above in connection with FIGS. 2D and 2E. In some cases, certain OPs (e.g., OP4, OP5, OP6, and OP7 in the implementation shown in FIG. 2G) may be reserved for future use.

As described above, in some implementations multiple HCs associated with a user data block (e.g., user data block 200) may be utilized, such as in implementations in which a PING HC is used to track accesses concurrently with a PONG HC being reduced (e.g., decayed and/or reset), and/or in which the PONG HC is used to track accesses concurrently with the PING HC being reduced (e.g., decayed and/or reset). Accordingly, in some implementations, one or more of the reserved OPs described above may be used to indicate certain parameters associated with the multiple HCs (e.g., the PING HC and/or the PONG HC).

More particularly, reference number 272 in FIG. 2H indicates another MR that may be used to configure an HC. In some implementations, the MR indicated by reference number 268 may be another implementation of HC2. In this implementation, HC2 may also include eight OPs, indexed as OP0 through OP7. Moreover, similar to the implementation described above in connection with FIG. 2G, OP0 and OP1 may be used to indicate an HC start/type, and/or OP2 and OP3 may be used to indicate an HC reset/decay type. In this implementation, however, OP4 may be used to indicate an HC mode selection. For example, when OP4 is set to 0 b, a first HC (e.g., a PING HC) is to start counting while a second HC (e.g., a PONG HC) is to be decayed and/or reset. On the other hand, when OP4 is set to 1 b, the second HC (e.g., the PONG HC) is to start counting while the first HC (e.g., the PING HC) is to be decayed and/or reset. In this way, at least one HC may be active at all times, such that accesses to a user data block (e.g., user data block 200) may be tracked even during a special refresh command. Put another way, during periods of time in which OP4 of this implementation of the HC2 is set to 0 b, tracking may be active by a PING HC and tracking may be paused for a PONG HC (e.g., such that it may be reset and/or decayed according to the reset/decay type indicated by OP2 and OP3). Periodically, in order to reset or decay the PING HC, OP4 of the HC2 may be set to 1 b, at which point tracking may be commenced for the PONG HC and paused for the PING HC (e.g., such that it may be reset and/or decayed according to the reset/decay type indicated by OP2 and OP3). In such implementations, twice as many bits may be used in the memory array to store the HCs as are used for a single HC, because two separate HCs may be stored in the user data block (e.g., on die 8 of the user data block 200 shown in FIG. 2A).

As indicated above, FIGS. 2A-2H are provided as an example. Other examples may differ from what is described with regard to FIGS. 2A-2H.

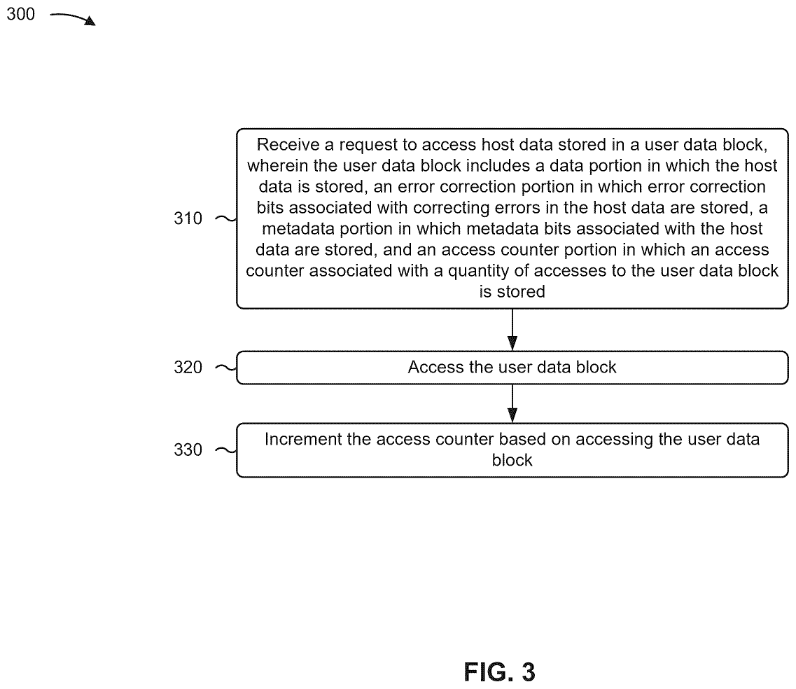

FIG. 3 is a flowchart of an example method 300 associated with using a user data block level access counter. In some implementations, a memory device (e.g., the memory device 120) may perform or may be configured to perform the method 300. In some implementations, another device or a group of devices separate from or including the memory device (e.g., the system 100 and/or the memory system 110) may perform or may be configured to perform the method 300. Additionally, or alternatively, one or more components of the memory device and/or the other device or group of devices separate from or including the memory device (e.g., the memory system controller 115 and/or the local controller 125, among other examples) may perform or may be configured to perform the method 300. Thus, means for performing the method 300 may include the memory device (e.g., memory device 120) and/or one or more components of the memory device, and/or the memory system (e.g., memory system 110) and/or one or more components of the memory system. Additionally, or alternatively, a non-transitory computer-readable medium may store one or more instructions that, when executed by the memory device and/or the memory system (e.g., the local controller 125 of the memory device 120 and/or the memory system controller 115), cause the memory device and/or the memory system to perform the method 300.

As shown in FIG. 3, the method 300 may include receiving a request to access host data stored in a user data block, wherein the user data block includes a data portion in which the host data is stored, an error correction portion in which error correction bits associated with correcting errors in the host data are stored, a metadata portion in which metadata bits associated with the host data are stored, and an access counter portion in which an access counter associated with a quantity of accesses to the user data block is stored (block 310). For example, a memory device 120 may receive a request to access (e.g., read and/or write) the user data block 200, which includes a data portion (e.g., data dies 202), an error correction portion (e.g., the portion of the extra dies 204 used to store the parity information and/or the CRC information), a metadata portion (e.g., the portion of the extra dies 204 used to store the metadata), and an access counter portion (e.g., the portion of the extra dies 204 used to store the HC, as one example of an access counter). As further shown in FIG. 3, the method 300 may include accessing the user data block (block 320). For example, the memory device 120 may access host data stored on the data dies 202 of the user data block 200, such as by performing a read and/or write operation. As further shown in FIG. 3, the method 300 may include incrementing the access counter based on accessing the user data block (block 330). For example, the memory device may increment the HC stored in the extra dies 204 of the user data block 200, as described above in connection with FIGS. 2B-2H.

The method 300 may include additional aspects, such as any single aspect or any combination of aspects described below and/or described in connection with one or more other methods or operations described elsewhere herein.

In a first aspect, the user data block includes multiple memory components, wherein the data portion is associated with a first subset of memory components of the memory components, wherein the error correction portion is associated with a second subset of memory components, of the memory components, and wherein the access counter portion and the metadata portion are included on a memory component of the second subset of memory components. For example, the user data block 200 may include multiple (e.g., ten) dies, with the data portion being associated with a first subset of dies (e.g., dies 0 through 7), with the error correction portion being associated with a second subset of the dies (e.g., dies 8 through 9), and with the access counter portion and the metadata portion being included on a die (e.g., die 8) of the second subset of dies.

In a second aspect, alone or in combination with the first aspect, the method 300 includes one of masking beats associated with the access counter when determining channel parity information for the user data block, or using a fixed value in place of the beats associated with the access counter when performing at least one of a read operation or a write operation for the user data block. For example, the memory device 120 may mask the HC beats on the ASIC error manager in order to read the actual HC beats from the DQs without altering the channel parity, and/or the memory device 120 may force a fixed value (e.g., 00 h) on the HC beats in read in order to preserve the error correction capability of the parity bits, as described above in connection with FIG. 2C.

In a third aspect, alone or in combination with one or more of the first and second aspects, incrementing the access counter comprises activating the access counter portion and multiple other access counter portions associated with multiple other access counters, incrementing the access counter, and refraining from incrementing the multiple other access counters. For example, as described above in connection with FIGS. 2B and 2D, the memory device 120 may activate multiple HCs belonging to a same row (e.g., HC₀ through HC₁₂₇), and the memory device 120 may activate one of the activated HCs (e.g., HCⱼ) while refraining from activating the other activated HCs.

In a fourth aspect, alone or in combination with one or more of the first through third aspects, the method 300 includes identifying, by the memory device using the access counter, that the quantity of accesses to the user data block satisfies a threshold, and causing, by the memory device, an alert signal to be transmitted based on identifying that the quantity of accesses to the user data block satisfies the threshold. For example, the memory device 120 may cause an alert (e.g., Alert_n) to be asserted when the HC exceeds a threshold, as described above in connection with FIGS. 2D and 2E.

In a fifth aspect, alone or in combination with one or more of the first through fourth aspects, the method 300 includes determining, by the memory device, that a time period has elapsed, and reducing, by the memory device, the access counter based on determining that the time period has elapsed. For example, the memory device 120 may use a SREF command to decay and/or reset the HC, as described above in connection with FIGS. 2D-2H.

In a sixth aspect, alone or in combination with one or more of the first through fifth aspects, the method 300 includes reducing, by the memory device, multiple access counters associated with multiple other user data blocks based on determining that the time period has elapsed. For example, the memory device 120 may decay and/or reset the HCs associated with an entire row of a memory array (e.g., HCₘ and HCₙ, among others), as described above in connection with FIG. 2E.

In a seventh aspect, alone or in combination with one or more of the first through sixth aspects, the time period is an integer multiple of a reference time period. For example, the time period may be a multiple of 32 ms and/or another reference time period (e.g., tREF), as described above in connection with FIG. 2E.

In an eighth aspect, alone or in combination with one or more of the first through seventh aspects, the method 300 includes receiving, by the memory device, configuration information configuring one or more parameters associated with the access counter via one or more mode registers associated with the user data block. For example, the memory device 120 may receive configuration information via one or more of the MRs described above in connection with FIGS. 2F-2G.

In a ninth aspect, alone or in combination with one or more of the first through eighth aspects, the one or more parameters include at least one of an access-counter threshold, a size of the access counter portion, enablement of the access counter, support of the access counter, enablement of a reduction of the access counter, a reduction type for reducing the access counter, a type of one or more accesses to the user data block that are to be counted by the access counter, or enablement of one access counter, of multiple access counters associated with the user data block. For example, the configuration information may indicate various parameters using the OPs described above in connection with the MRs of FIGS. 2F-2G.

In a tenth aspect, alone or in combination with one or more of the first through ninth aspects, the user data block is associated with another access counter, and wherein the method further comprises reducing, by the memory device, the other access counter concurrently with incrementing the access counter. For example, the user data block 200 may be associated with a PING HC and a PONG HC, such that one of the PING HC or the PONG HC is incremented during a period of time in which the other one of the PING HC or the PONG HC is reset or decayed, as described above in connection with FIGS. 2G and 2H.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

In some implementations, a memory device includes one or more components configured to: receive, from a host device, a request to access host data stored in a user data block, wherein the user data block includes: a data portion in which the host data is stored, an error correction portion in which error correction bits associated with correcting errors in the host data are stored, a metadata portion in which metadata bits associated with the host data are stored, and an access counter portion in which an access counter associated with a quantity of accesses to the user data block is stored; access the user data block; and increment the access counter based on accessing the user data block.

In some implementations, a method includes receiving, by a memory device from a host device, a request to access host data stored in a user data block, wherein the user data block includes: a data portion in which the host data is stored, an error correction portion in which error correction bits associated with correcting errors in the host data are stored, a metadata portion in which metadata bits associated with the host data are stored, and an access counter portion in which an access counter associated with a quantity of accesses to the user data block is stored; accessing, by a memory device, the user data block; and incrementing, by the memory device, the access counter based on accessing the user data block.

In some implementations, a memory device includes one or more components configured to: receive, from a host device, a request to access host data stored in a user data block, wherein the user data block includes: a data portion in which the host data is stored, an error correction portion in which error correction bits associated with correcting errors in the host data are stored, a metadata portion in which metadata bits associated with the host data are stored, and an access counter portion in which multiple access counters associated with a quantity of accesses to the user data block are stored; access the user data block; increment a first access counter, of the multiple access counters, based on accessing the user data block; and reduce a second access counter, of the multiple access counters, concurrently with incrementing the first access counter.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive, from a host device, a request to access host data stored in a user data block, wherein the user data block includes:
a data portion in which the host data is stored,
an error correction portion in which error correction bits associated with correcting errors in the host data are stored,
a metadata portion in which metadata bits associated with the host data are stored, and
an access counter portion in which an access counter associated with a quantity of accesses to the user data block is stored;
access the user data block; and
increment the access counter based on accessing the user data block.

2. The memory device of claim 1, wherein the user data block includes multiple memory components,
wherein the data portion is associated with a first subset of memory components, of the memory components,
wherein the error correction portion is associated with a second subset of memory components, of the memory components, and
wherein the access counter portion and the metadata portion are included on a memory component of the second subset of memory components.

3. The memory device of claim 1, wherein the one or more components are further configured to one of:
mask beats associated with the access counter when determining channel parity information for the user data block, or
use a fixed value in place of the beats associated with the access counter when performing at least one of a read operation or a write operation for the user data block.

4. The memory device of claim 1, wherein one or more components, to increment the access counter, are configured to:
activate the access counter portion and multiple other access counter portions associated with multiple other access counters;
increment the access counter; and
refrain from incrementing the multiple other access counters.

5. The memory device of claim 1, wherein the one or more components are further configured to:
identify, using the access counter, that the quantity of accesses to the user data block satisfies a threshold; and
cause an alert signal to be transmitted based on identifying that the quantity of accesses to the user data block satisfies the threshold.

6. The memory device of claim 1, wherein the one or more components are further configured:
determine that a time period has elapsed; and
reduce the access counter based on determining that the time period has elapsed.

7. The memory device of claim 6, wherein the one or more components are further configured to reduce multiple access counters associated with multiple other user data blocks based on determining that the time period has elapsed.

8. The memory device of claim 6, wherein the time period is an integer multiple of a reference time period.

9. The memory device of claim 1, wherein the one or more components are further configured to receive configuration information configuring one or more parameters associated with the access counter via one or more mode registers associated with the user data block.

10. The memory device of claim 9, wherein the one or more parameters include at least one of:
an access-counter threshold,
a size of the access counter portion,
enablement of the access counter,
support of the access counter,
enablement of a reduction of the access counter,
a reduction type for reducing the access counter,
a type of one or more accesses to the user data block that are to be counted by the access counter, or
enablement of one access counter, of multiple access counters associated with the user data block.

11. The memory device of claim 1, wherein the user data block is associated with another access counter, and
wherein the one or more components are further configured to reduce the other access counter concurrently with incrementing the access counter.

12. A method, comprising:
receiving, by a memory device from a host device, a request to access host data stored in a user data block, wherein the user data block includes:
a data portion in which the host data is stored,
an error correction portion in which error correction bits associated with correcting errors in the host data are stored,
a metadata portion in which metadata bits associated with the host data are stored, and
an access counter portion in which an access counter associated with a quantity of accesses to the user data block is stored;
accessing, by a memory device, the user data block; and
incrementing, by the memory device, the access counter based on accessing the user data block.

13. The method of claim 12, wherein incrementing the access counter comprises:
activating, by the memory device, the access counter portion and multiple other access counter portions associated with multiple other access counters;
incrementing, by the memory device, the access counter; and
refraining from incrementing, by the memory device, the multiple other access counters.

14. The method of claim 12, further comprising:
identifying, by the memory device using the access counter, that the quantity of accesses to the user data block satisfies a threshold; and
causing, by the memory device, an alert signal to be transmitted based on identifying that the quantity of accesses to the user data block satisfies the threshold.

15. The method of claim 12, further comprising:
determining, by the memory device, that a time period has elapsed; and
reducing, by the memory device, the access counter based on determining that the time period has elapsed.

16. The method of claim 12, wherein the user data block is associated with another access counter, and
wherein the method further comprises reducing, by the memory device, the other access counter concurrently with incrementing the access counter.

17. A memory device, comprising:
one or more components configured to:
receive, from a host device, a request to access host data stored in a user data block, wherein the user data block includes:
a data portion in which the host data is stored,
an error correction portion in which error correction bits associated with correcting errors in the host data are stored,
a metadata portion in which metadata bits associated with the host data are stored, and
an access counter portion in which multiple access counters associated with a quantity of accesses to the user data block are stored;
access the user data block;
increment a first access counter, of the multiple access counters, based on accessing the user data block; and
reduce a second access counter, of the multiple access counters, concurrently with incrementing the first access counter.

18. The memory device of claim 17, wherein the one or more components are further configured to one of:
mask beats associated with the access counter when determining channel parity information for the user data block, or
use a fixed value in place of the beats associated with the access counter when performing at least one of a read operation or a write operation for the user data block.

19. The memory device of claim 17, wherein one or more components, to increment the first access counter, are configured to:
activate the access counter portion and multiple other access counter portions associated with multiple other access counters;
increment the first access counter; and
refrain from incrementing the multiple other access counters.

20. The memory device of claim 17, wherein the one or more components are further configured to:
identify, using the first access counter, that the quantity of accesses to the user data block satisfies a threshold; and
cause an alert signal to be transmitted based on identifying that the quantity of accesses to the user data block satisfies the threshold.
